(19) United States
(12) Patent Application Publication
(10) Pub. No.: US 2019/0382034 A1
(43) Pub. Date: Dec. 19, 2019

(54) SYSTEMS AND METHODS FOR ACTIVE TIRE PERFORMANCE MONITORING

(71) Applicant: GM GLOBAL TECHNOLOGY OPERATIONS LLC, Detroit, MI (US)

(72) Inventors: Justin T. Miller, Southfield, MI (US); Eric J. Borcherding, Denver, CO (US)

(21) Appl. No.: 16/007,262

(22) Filed: Jun. 13, 2018

(51) Int. Cl. B60W 50/14; B60C 23/06; B60C 23/04; B60C 23/00; B60Q 9/00; B60W 50/00

(52) U.S. Cl. CPC B60W 50/14; B60C 23/061; B60C 23/0488; B60C 17/00; B60Q 9/00; B60W 50/0098; B60C 23/003

(57) ABSTRACT

An exemplary method for monitoring tire performance includes the steps of providing a wheel assembly comprising a tire and a tire characteristic sensor, providing a vehicle sensor configured to measure a vehicle characteristic, providing a controller in electronic communication with the tire characteristic sensor and the vehicle sensor, receiving, by the controller, tire characteristic data from the tire characteristic sensor and vehicle characteristic data from the vehicle sensor, determining, by the controller, whether a first condition is satisfied, if the first condition is satisfied, monitoring, by the controller, the tire characteristic data, determining, by the controller, an acceleration of the tire from the tire characteristic data, determining, by the controller, whether a second condition is satisfied, and if the second condition is satisfied, generating, by the controller, a control signal.

### INTRODUCTION

The present invention relates generally to the field of vehicles and, more specifically, to systems and method for active tire performance monitoring of a run-flat tire.

A run-flat tire is a pneumatic vehicle tire that is designed to resist the effects of deflation when punctured, and to enable the vehicle to continue to be driven at reduced speeds and for limited distances, depending on the type of tire. Run-flat tires have a finite endurance life after achieving near zero pressure status. After pressure loss, tire handling capacity degrades as the tire structure begins to fail.

### SUMMARY

Embodiments according to the present disclosure provide a number of advantages. For example, embodiments according to the present disclosure enable monitoring a tire-mounted accelerometer to determine and track the loss in handling capacity, compare the current performance against known levels of acceptable performance, and inform the operator that the tire handling capacity has been reduced past the point where the vehicle can be operated safely.

In one aspect, a method for monitoring tire performance includes the steps of providing a wheel assembly comprising a tire and a tire characteristic sensor, providing a vehicle sensor configured to measure a vehicle characteristic, and providing a controller in electronic communication with the tire characteristic sensor and the vehicle sensor. In various aspects, the method includes receiving, by the controller, tire characteristic data from the tire characteristic sensor and vehicle characteristic data from the vehicle sensor, determining, by the controller, whether a first condition is satisfied, if the first condition is satisfied, monitoring, by the controller, the tire characteristic data, determining, by the controller, an acceleration of the tire from the tire characteristic data, determining, by the controller, whether a second condition is satisfied, and if the second condition is satisfied, generating, by the controller, a control signal.

In some aspects, the tire characteristic sensor is an accelerometer.

In some aspects, the vehicle sensor is a pressure sensor.

In some aspects, the vehicle characteristic is a tire pressure.

In some aspects, the first condition is a run-flat condition of the tire.

In some aspects, the first condition is a tire pressure threshold and the first condition is satisfied when the tire pressure is lower than the tire pressure threshold.

In some aspects, determining the acceleration of the tire includes determining a radial acceleration of the tire and the method further includes determining, by the controller, a length of a contact portion of the tire with a surface, and monitoring, by the controller, a change in the length of the contact portion.

In some aspects, the second condition is a contact portion threshold, and the second condition is satisfied when the length of the contact portion exceeds the contact portion threshold, and generating the control signal includes generating one or more of a warning command and a control command.

In some aspects, determining the acceleration of the tire includes determining a lateral acceleration of the tire and the method further includes determining, by the controller, a lateral force capacity of the tire, and monitoring, by the controller, a change in the lateral force capacity.

In some aspects, the second condition is a lateral force capability threshold of the tire and the second condition is satisfied when the lateral force capacity exceeds the lateral force capacity threshold, and generating the control signal includes generating one or more of a warning command and a control command.

In some aspects, determining the acceleration of the tire from the tire characteristic data further includes determining a degradation condition of the tire.

In another aspect, a method for monitoring tire performance includes the steps of providing a wheel assembly comprising a tire and an accelerometer, providing a pressure sensor configured to measure a tire pressure, and providing a controller in electronic communication with the accelerometer and the pressure sensor. In various aspects, the method includes continuously receiving, by the controller, radial acceleration data of the tire from the accelerometer and tire pressure data from the pressure sensor, determining, by the controller, whether the tire pressure is below a tire pressure threshold, if the tire pressure is below the tire pressure threshold, monitoring, by the controller, the radial acceleration data, determining, by the controller, a length of a contact portion of the tire with a surface, monitoring, by the controller, a change in length of the contact portion, determining, by the controller, whether the length of the contact portion exceeds a contact portion threshold, and if the length of the contact portion exceeds the contact portion threshold, generating, by the controller, one or more of a warning command and a control command.

In some aspects, the method further includes providing an operator notification system and transmitting, by the controller, the warning command to the operator notification system.

In some aspects, the control command is a control signal to control a vehicle system.

In some aspects, determining whether the tire pressure is below a tire pressure threshold includes determining if the tire is in a run-flat condition.

In some aspects, determining the length of the contact portion includes determining a degradation condition of the tire.

In yet another aspect, a method for monitoring tire performance includes the steps of providing a wheel assembly comprising a tire and an accelerometer embedded within a wall of the tire, providing a pressure sensor configured to measure a tire pressure, and providing a controller in electronic communication with the accelerometer and the pressure sensor. In various aspects, the method includes continuously receiving, by the controller, lateral acceleration data of the tire from the accelerometer and tire pressure data from the pressure sensor, determining, by the controller, whether the tire pressure is below a tire pressure threshold, if the tire pressure is below the tire pressure threshold, monitoring, by the controller, the lateral acceleration data, determining, by the controller, a lateral force capacity of the tire, monitoring, by the controller, a change in the lateral force capacity of the tire, determining, by the controller, whether the lateral force capacity of the tire exceeds a lateral force capacity threshold, and if the lateral force capacity exceeds the lateral force capacity threshold, generating, by the controller, one or more of a warning command and a control command.

In some aspects, the method further includes providing an operator notification system and transmitting, by the controller, the warning command to the operator notification system.

In some aspects, determining whether the tire pressure is below a tire pressure threshold includes determining if the tire is in a run-flat condition.

In some aspects, determining the lateral force capacity of the tire includes determining a degradation condition of the tire.

### BRIEF DESCRIPTION OF THE DRAWINGS

The present disclosure will be described in conjunction with the following figures, wherein like numerals denote like elements.

FIG. 1 is a functional block diagram of a vehicle that includes, among other features, a plurality of tires, in accordance with exemplary embodiments.

FIG. 2 is a functional block diagram of a controller including a tire performance monitoring system, according to an embodiment.

FIG. 3A is a schematic diagram of a tire having a tire performance sensor and operating in a first condition, according to an embodiment.

FIG. 3B is a graphical illustration of a radial acceleration of the tire of FIG. 3A, according to an embodiment.

FIG. 4A is a schematic diagram of a tire having a tire performance sensor and operating in a second condition, according to an embodiment.

FIG. 4B is a graphical illustration of a radial acceleration of the tire of FIG. 4A, according to an embodiment.

FIG. 5A is a schematic diagram of a tire having a tire performance sensor and operating in a third condition, according to an embodiment.

FIG. 5B is a graphical illustration of a radial acceleration of the tire of FIG. 5A, according to an embodiment.

FIG. 6A is a graphical illustration of a lateral force of a tire, according to an embodiment.

FIG. 6B is a graphical illustration of a lateral acceleration of the tire correlated to the lateral force data shown in FIG. 6A, according to an embodiment.

FIG. 6C is a graphical illustration of a predicted lateral acceleration of the tire, according to an embodiment.

FIG. 7 is a flow diagram of a method for monitoring tire performance, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

The main components that determine tire handling capacity reduction are loss in air pressure due to puncture, structural degradation of a run-flat tire insert due to vehicle load, and handling maneuvers attempted after the tire has deflated. The amount of performance loss due to puncture and structural degradation vary widely based on the tire's construction and vehicle usage. Current run-flat tire validation criteria cannot cover every condition the operator may encounter. Added safety monitoring, as discussed below, will allow for safer operation of the vehicle in non-standard driving situations.

By monitoring a tire-mounted accelerometer, a loss in handling capacity can be tracked, compared against known levels of acceptable performance, and used to alert the operator that the tire handling capacity has reduced past the point where the vehicle can be operated safely.

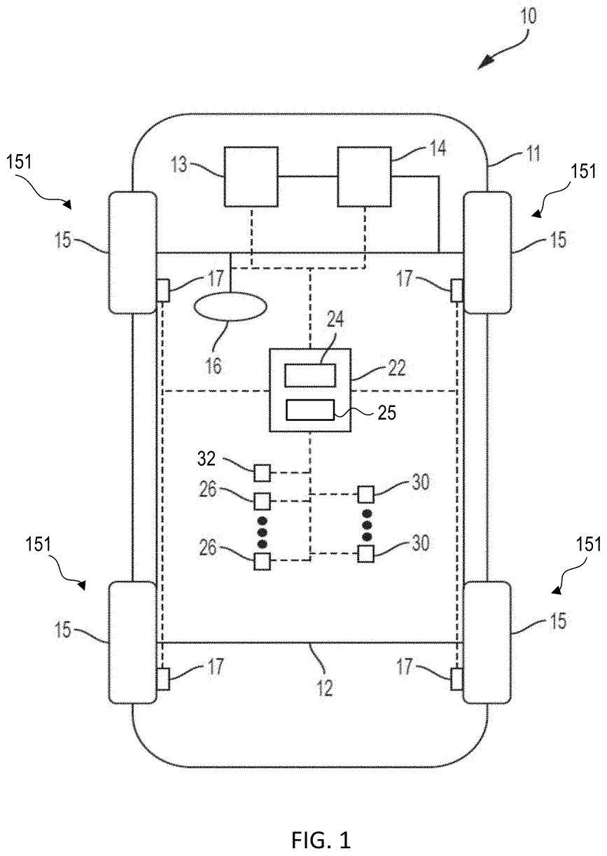

FIG. 1 schematically illustrates an automotive vehicle 10 according to the present disclosure. Although the figures shown herein depict an example with certain arrangements of elements, additional intervening elements, devices, features, or components may be present in an actual embodiment. It should also be understood that FIG. 1 is merely illustrative and may not be drawn to scale.

The vehicle 10 generally includes a body 11, a chassis 12, and wheel assemblies 151. The body 11 is arranged on the chassis 12 and substantially encloses the other components of the vehicle 10. The body 11 and chassis 12 may jointly form a frame. The wheel assemblies 151 are each rotationally coupled to the chassis 12 near a respective corner of the body 11 via one or more suspension system components (not shown). Each of the wheel assemblies 151 includes a tire 15 coupled to a wheel (not shown). The vehicle 10 is depicted in the illustrated embodiment as a passenger car, but it should be appreciated that any other vehicle including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheel assemblies 151 according to selectable speed ratios. According to various embodiments, the transmission 14 may include a step-ratio automatic transmission, a continuously-variable transmission, or other appropriate transmission. The vehicle 10 additionally includes a brake assembly 17 configured to provide braking torque to the vehicle wheel assemblies 151. The brake assembly 17 may, in various embodiments, include friction brakes, a regenerative braking system such as an electric machine, and/or other appropriate braking systems. In some embodiments, the brake assembly 17 is an electromechanical brake assembly that includes at least one brake pad, a brake caliper, a brake rotor, and a drive unit.

The vehicle 10 additionally includes a steering system 16. In various embodiments, the steering system 16 is any type of steering system including, for example and without limitation, a steer-by-wire system that makes use of electric motors to turn the wheels, sensors to determine how much steering force to apply, and steering feel emulators to provide haptic feedback to the driver via a steering wheel (not shown) or a rack-and-pinion steering system.

With further reference to FIG. 1, the vehicle 10 also includes a sensing system including a plurality of sensors 26 configured to measure and capture data on one or more vehicle characteristics, including but not limited to vehicle speed, brake pressure, tire pressure, steering wheel angle, yaw velocity, etc. In the illustrated embodiment, the sensors 26 include, but are not limited to, an accelerometer, a speed sensor, a pressure sensor, or other sensors that sense observable conditions of the vehicle or the environment surrounding the vehicle and may include RADAR, LIDAR, optical cameras, thermal cameras, ultrasonic sensors, and/or additional sensors as appropriate. The vehicle 10 also includes a plurality of actuators 30 configured to receive control commands to control steering, shifting, throttle, braking, or other aspects of the vehicle 10.

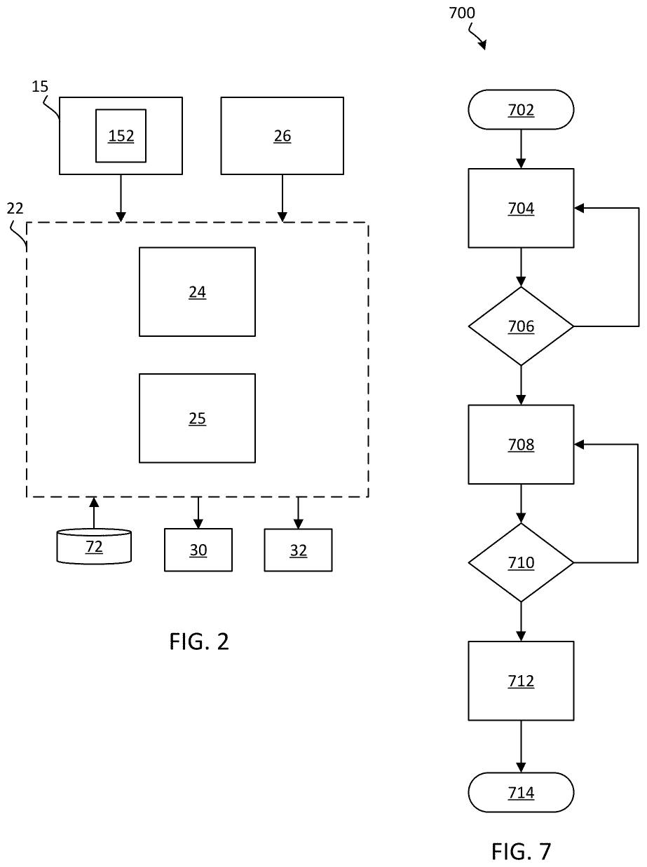

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media 72 (see FIG. 2). Computer readable storage devices or media 72 may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media 72 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle, including the brake assembly 17 and the steering system 16.

As shown in FIGS. 1 and 2, in some embodiments, the controller 22 includes a tire performance monitoring system 24. A sensor 152 embedded within each of the tires 15 is in electronic communication with the controller 22 via either a wired or wireless connection. The tire performance monitoring system 24 receives data from the sensor 152 embedded in the tire 15 and synthesizes and analyzes the data to determine a current tire performance and predict a tire endurance. In some embodiments, the sensor 152 is an accelerometer. The computer-readable storage devices or media 72 are in electronic communication with the controller 22 and are capable of storing data, such as tire performance data as well as executable instructions used by the tire performance monitoring system 24 of the controller 22.

In accordance with various embodiments, controller 22 implements an autonomous driving system (ADS) 25 as shown in FIGS. 1 and 2. That is, suitable software and/or hardware components of controller 22 (e.g., a processor and a computer-readable storage device) are utilized to provide an autonomous driving system 25 that is used in conjunction with vehicle 10. The controller 22 receives sensor data from the plurality of sensors 26 and generates one or more command or control signals that are transmitted to the plurality of actuators 30 to control the vehicle 10 in accordance with the autonomous driving system 25. In various embodiments, the controller 22 generates a warning signal that is transmitted to an operator notification system 32. In some embodiments, the operator notification system 32 includes components such as a display, speakers, etc. that provide visual and/or auditory notifications to the vehicle operator of various vehicle conditions, such as low tire pressure, and a run-flat tire performance level, for example and without limitation.

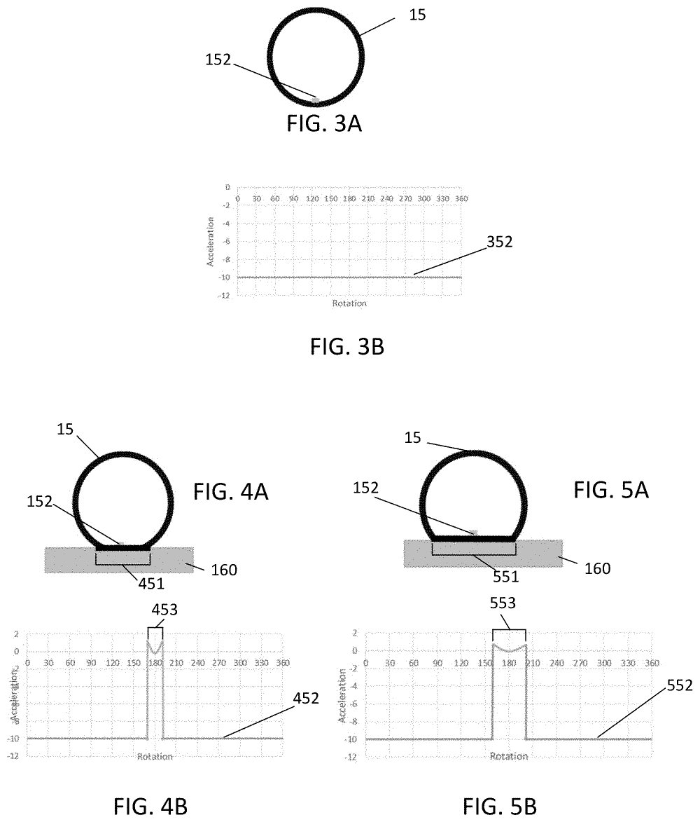

FIGS. 3-5 illustrate a radial acceleration response under various operating conditions of a run-flat tire, such as the tires 15, having a sensor 152 embedded within a wall of the tire 15. The sensor 152 is operable to sense a change in amplitude of a radial acceleration of the tire 15 for each revolution of the tire 15, as the tire 15 rotates about a rotation axis.

FIG. 3A illustrates a tire 15 operating in a free rotation condition. A free rotation condition occurs when the tire is rotating without contact with a surface. As graphically illustrated in FIG. 3B, the radial acceleration 352 of the tire 15, as measured by the sensor 152, is constant when the tire 15 is freely rotating. The graphical representation shown in FIG. 3B illustrates that the tire 15 is not undergoing deformation while freely rotating.

FIG. 4A illustrates a tire 15 operating in a run-flat condition. A run-flat condition occurs when the tire 15 is at least partially deflated and is rotating along a surface, such as the surface 160. As the tire 15 rotates in a partially deflated condition, a portion of the tire 15 deforms upon contact with the surface 160, as illustrated by a contact portion or patch 451. The amount of deformation, and thus the size of the contact portion 451, increases as the side wall of the tire 15 degrades during run-flat operation. As shown in FIG. 4B, the radial acceleration of the tire 15 as illustrated by the line 452 is generally flat until the sensor 152 passes through the contact portion 451. As tire 15 rotates and the sensor 152 passes through the contact portion 451, the sensor 152 registers a radial acceleration change. This radial acceleration change is illustrated in the acceleration profile of FIG. 4B by the graphical segment 453. The length of the segment 453 graphically illustrates an amount of deformation of the tire 15. Through analysis of the accelerometer data and comparison of the accelerometer data with data representing various inflation conditions, the radial acceleration data represented by the line 452 is used to monitor tire performance and determine a degradation condition.

FIG. 5A illustrates a tire 15 operating in a degraded condition. A degraded condition occurs when the tire 15 is deflated beyond a specified inflation level. At inflation levels lower than the specified level, the amount of deformation of the tire 15 increases beyond a specified deformation threshold. Operation of the tire 15 beyond the specified deformation level may lead to an unsafe operating condition of the vehicle 10. As shown in FIG. 5A, the size of the contact portion 551 is larger than when the tire 15 is in a partially deflated but acceptable run-flat condition, as shown in FIG. 4A. The radial acceleration change registered by the sensor 152 as the tire 15 rotates along the surface 160 in a degraded condition is graphically illustrated by segment 553 of the acceleration profile shown in FIG. 5B. As compared with the acceleration profile shown in FIG. 4B, the length of the segment 553 is larger than segment 453, consistent with a degraded tire condition versus a run-flat tire operating condition.

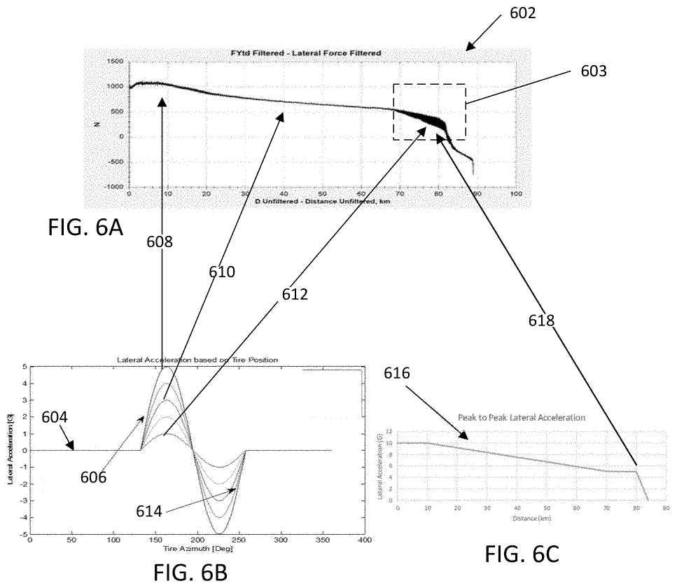

FIG. 6 graphically illustrates a lateral acceleration response measured by the embedded sensor 152 of a run-flat tire operating at zero pressure, such as the tires 15, with the tire performance degradation depicted for one rotational cycle of the tire 15 (see FIG. 6B). FIG. 6A is a graphical representation of a lateral force data signal 602 measured by the sensor 152 of the tire 15 over a traveling distance. FIG. 6B is a graphical representation of five snapshots of the lateral acceleration of the tire 15 measured as the sensor 152 travels through the contact portion during one revolution of the tire with each snapshot illustrating a given point of tire degradation during zero pressure operation. FIG. 6C is a graphical representation of an idealized or predicted peak to peak data signal from the sensor 152 during an extended zero pressure operating condition of the tire 15.

With reference to FIG. 6A, as the tire 15 approaches a level of unacceptable degradation, thresholding occurs, as illustrated by the area of enclosed by box 603. This area of thresholding corresponds to the lateral acceleration drop off shown in FIG. 6C, with the correspondence indicated by arrow 618.

With reference to FIG. 6B, as the sensor 152 rotates into the contact portion, as indicated by arrow 606, a data signal is captured. The peak to peak magnitude of the lateral acceleration measured by the sensor 152 depends on the operating condition of the tire 15. For example, data signal 608 represents the tire 15 operating in a run-flat condition prior to degradation. Data signal 610 represents the tire 15 operating in a run-flat condition during partial degradation but within acceptable operating limits. Data signal 612 represents the tire 15 operating in a run-flat condition at a degradation level outside of acceptable operating limits. As the sensor 152 rotates out of the contact portion, as indicated by arrow 614, the data signal 604 returns to a flat line. By monitoring the lateral acceleration through the contact patch or portion using the accelerometer 152, a vehicle controller, such as the controller 22, can determine whether the tire 15 is operating in an acceptable or unacceptable run-flat condition during a zero pressure event.

A predicted peak to peak acceleration signal 616 of the tire 15 through the contact portion during zero pressure operation is illustrated in FIG. 6C. The lateral acceleration decreases as the distance the tire 15 continues in operation in during a zero pressure event increases. The data signal from the sensor 152 can be compared to the predicted accelerometer data signal 616 shown in FIG. 6C. The predicted accelerometer data is used to establish a threshold operating condition to determine whether the performance of the tire 15 is in an acceptable or unacceptable condition. As discussed above with respect to FIG. 6A, the thresholding that occurs before the tire 15 reaches an unacceptable level of degradation, or failure, is illustrated by the measured and predicted tire performance data. Thresholds of tire degradation are scalable and tunable based on the tire size, tire type, vehicle size, vehicle type, etc., among other features for example and without limitation.

FIG. 7 illustrates a method 700 to monitor performance of a run-flat tire, according to an embodiment. The method 700 can be utilized in connection with the tires 15 of the wheel assemblies 151 and the tire performance monitoring system 24 of the controller 22 of the vehicle 10. The method 700 can be utilized in connection with the controller 22 as discussed herein, or by other systems associated with or separate from the vehicle, in accordance with exemplary embodiments. The order of operation of the method 700 is not limited to the sequential execution as illustrated in FIG. 7, but may be performed in one or more varying orders, or steps may be performed simultaneously, as applicable in accordance with the present disclosure.

The method 700 begins at 702 and proceeds to 704. At 704, the tire performance monitoring system 24 of the controller 22 receives sensor data from one or more vehicle sensors, such as the sensors 26 and the sensors 152. The sensors 26, 152 provide sensor data indicative of various vehicle operating conditions, such as vehicle speed, tire pressure, radial acceleration of one or more tires, and lateral acceleration of one or more tires, for example and without limitation.

Next, at 706, the controller 22 determines from the sensor data whether a first condition is satisfied. In some embodiments, the first condition is a specified tire pressure level. In some embodiments, the specified tire pressure level is a zero or low tire pressure condition. In some embodiments, the specified tire pressure level is approximately zero (0) psi. In some embodiments, the tire pressure level is less than five (5) psi.

If the sensor data indicates that the first condition is not satisfied, that is, in some embodiments, that the tire pressure is not below the specified tire pressure level, the method 700 returns to 704 and the controller 22 continues to receive and monitor the sensor data generated by the sensors 26, 152.

If the sensor data indicates that the first condition is satisfied, that is, that the tire pressure is below the specified tire pressure level, the method 700 proceeds to 708. At 708, the controller 22 monitors the sensor data received from the sensor(s) 152.

In some embodiments, the sensor data from the sensor(s) 152 indicates a radial acceleration of the tire 15, as shown in FIGS. 3-5 and discussed herein. At 708, the controller 22 receives the radial acceleration data, determines a length of the contact portion from the radial acceleration data, and monitors a change in the length of the contact portion.

In some embodiments, the sensor data from the sensor(s) 152 indicates a lateral acceleration of the tire 15, as shown in FIG. 6 and discussed herein. At 708, the controller 22 receives the lateral acceleration data and determines and monitors a lateral force capability of the tire 15.

Next, at 710, the controller 22 evaluates the length of the contact portion and/or the lateral force capability of the tire 15 to determine whether a second condition is satisfied. Satisfaction of the second condition indicates a likelihood that a run-flat performance capability of the tire 15 has fallen outside of acceptable operating limits. If the second condition is not satisfied, that is, a change in length of the contact portion does not exceed a length threshold and/or the lateral force capability of the tire 15 as indicated by the lateral acceleration does not exceed a force threshold, the method 700 returns to 708 and proceeds as discussed herein.

If the controller 22 determines that the second condition is satisfied, that is a change in length of the contact portion exceeds a length threshold and/or the lateral force capability of the tire 15 as indicated by the lateral acceleration exceeds a force threshold, a degraded tire condition exists and the method 700 proceeds to 712. At 712, the controller 22 generates one or more control signals. In some embodiments, the control signal is a warning command transmitted to the operator notification system 32 to notify the operator of the degraded tire condition. In some embodiments, the control signal is a control command to control steering, shifting, throttle, braking, or other aspects of the vehicle 10. The method 700 then proceeds to 714 and ends.

The systems and methods discussed herein may be used with any vehicle having a sensor-equipped and monitored run-flat tire including an autonomous, semi-autonomous, or directly-operated vehicle.

it should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, al of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should he interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for monitoring tire performance, the method comprising:
providing a wheel assembly comprising a tire and a tire characteristic sensor;
providing a vehicle sensor configured to measure a vehicle characteristic;
providing a controller in electronic communication with the tire characteristic sensor and the vehicle sensor;
receiving, by the controller, tire characteristic data from the tire characteristic sensor and vehicle characteristic data from the vehicle sensor;
determining, by the controller, whether a first condition is satisfied;
if the first condition is satisfied, monitoring, by the controller, the tire characteristic data;
determining, by the controller, an acceleration of the tire from the tire characteristic data;
determining, by the controller, whether a second condition is satisfied; and
if the second condition is satisfied, generating, by the controller, a control signal.

2. The method of claim 1, wherein the tire characteristic sensor is an accelerometer.

3. The method of claim 2, wherein the vehicle sensor is a pressure sensor.

4. The method of claim 3, wherein the vehicle characteristic is a tire pressure.

5. The method of claim 4, wherein the first condition is a run-flat condition of the tire.

6. The method of claim 4, wherein the first condition is a tire pressure threshold and the first condition is satisfied when the tire pressure is lower than the tire pressure threshold.

7. The method of claim 6, wherein determining the acceleration of the tire comprises determining a radial acceleration of the tire and the method further comprises determining, by the controller, a length of a contact portion of the tire with a surface, and monitoring, by the controller, a change in the length of the contact portion.

8. The method of claim 7, wherein the second condition is a contact portion threshold, and the second condition is satisfied when the length of the contact portion exceeds the contact portion threshold, and generating the control signal comprises generating one or more of a warning command and a control command.

9. The method of claim 6, wherein determining the acceleration of the tire comprises determining a lateral acceleration of the tire and the method further comprises determining, by the controller, a lateral force capacity of the tire, and monitoring, by the controller, a change in the lateral force capacity.

10. The method of claim 9, wherein the second condition is a lateral force capability threshold of the tire and the second condition is satisfied when the lateral force capacity exceeds the lateral force capacity threshold, and generating the control signal comprises generating one or more of a warning command and a control command.

11. The method of claim 1, wherein determining the acceleration of the tire from the tire characteristic data further comprises determining a degradation condition of the tire.

12. A method for monitoring tire performance, the method comprising:
providing a wheel assembly comprising a tire and an accelerometer;
providing a pressure sensor configured to measure a tire pressure;
providing a controller in electronic communication with the accelerometer and the pressure sensor;
continuously receiving, by the controller, radial acceleration data of the tire from the accelerometer and tire pressure data from the pressure sensor;
determining, by the controller, whether the tire pressure is below a tire pressure threshold;
if the tire pressure is below the tire pressure threshold, monitoring, by the controller, the radial acceleration data;
determining, by the controller, a length of a contact portion of the tire with a surface;
monitoring, by the controller, a change in length of the contact portion;
determining, by the controller, whether the length of the contact portion exceeds a contact portion threshold; and
if the length of the contact portion exceeds the contact portion threshold, generating, by the controller, one or more of a warning command and a control command.

13. The method of claim 12, further comprising providing an operator notification system and transmitting, by the controller, the warning command to the operator notification system.

14. The method of claim 12, wherein the control command is a control signal to control a vehicle system.

15. The method of claim 12, wherein determining whether the tire pressure is below a tire pressure threshold comprises determining if the tire is in a run-flat condition.

16. The method of claim 12, wherein determining the length of the contact portion comprises determining a degradation condition of the tire.

17. A method for monitoring tire performance, the method comprising:
providing a wheel assembly comprising a tire and an accelerometer embedded within a wall of the tire;
providing a pressure sensor configured to measure a tire pressure;
providing a controller in electronic communication with the accelerometer and the pressure sensor;
continuously receiving, by the controller, lateral acceleration data of the tire from the accelerometer and tire pressure data from the pressure sensor;
determining, by the controller, whether the tire pressure is below a tire pressure threshold;
if the tire pressure is below the tire pressure threshold, monitoring, by the controller, the lateral acceleration data;
determining, by the controller, a lateral force capacity of the tire;
monitoring, by the controller, a change in the lateral force capacity of the tire;
determining, by the controller, whether the lateral force capacity of the tire exceeds a lateral force capacity threshold; and
if the lateral force capacity exceeds the lateral force capacity threshold, generating, by the controller, one or more of a warning command and a control command.

18. The method of claim 17, further comprising providing an operator notification system and transmitting, by the controller, the warning command to the operator notification system.

19. The method of claim 17, wherein determining whether the tire pressure is below a tire pressure threshold comprises determining if the tire is in a run-flat condition.

20. The method of claim 17, wherein determining the lateral force capacity of the tire comprises determining a degradation condition of the tire.
